(19) United States
(12) Patent Application Publication
(10) Pub. No.: US 2024/0277176 A1
(43) Pub. Date: Aug. 22, 2024

(54) COOKING DEVICE

(71) Applicant: CUCHEN CO., LTD, Seoul (KR)

(72) Inventor: Kyu Hyun YEOM, Chungcheongnam-do (KR)

(21) Appl. No.: 18/567,371

(22) PCT Filed: Jun. 14, 2022
(86) PCT No.: PCT/KR2022/008411

§ 371 Date: Dec. 6, 2023

(30) Foreign Application Priority Data
Jun. 14, 2021 (KR) 10-2021-0077039

(51) Int. Cl. A47J 27/09; A47J 27/08

(52) U.S. Cl. CPC A47J 27/09; A47J 27/0802; A47J 27/0815

(57) ABSTRACT

A cooking device according to an exemplary embodiment of the present disclosure includes: a main body in which an inner pot is accommodated; a top plate provided in a lid cover coupled to the main body; a rotation cover coupled to the top plate to be rotatable along an edge of the top plate; a locking structure comprising a locking structure comprising an engagement protrusion configured to be engaged with a flange of the inner pot, wherein the locking structure is configured to linearly move, depending on a rotation angle of the rotation cover, between a locking position at which the engagement protrusion is located to overlap the flange of the inner pot in a vertical direction and an unlocking position spaced apart outward from the locking position in a radial direction.

### TECHNICAL FIELD

The present disclosure relates to a cooking device and, more particularly, to a cooking device that enables cooking ingredients to be safely cooked.

### BACKGROUND

In general, as a representative example of a cooking device, an electric pressure rice cooker is a device capable of selectively performing a cooking function for cooking rice and a warming function for maintaining cooked rice at a predetermined temperature. In an electric pressure rice cooker, a main body lid in which a steam discharge hole is formed may be installed on a main body to be openable/closable, an inner pot may be detachably built in the main body, and an inner pot lid may be separately provided to cover the inner pot. An induction heating-type or hot plate-type heater is provided in the main body to transfer heat to the cooking ingredients accommodated in the inner pot, such as rice, mixed grains, or other food ingredients, so that the cooking ingredients can be cooked.

### SUMMARY

In view of the foregoing, the present disclosure provides a cooking device that can be safely used even when a lid is incompletely closed.

A cooking device according to an embodiment of the present disclosure includes: a rotation cover coupled to the top plate to be rotatable along an edge of the top plate; a locking structure including an engagement protrusion configured to be engaged with a flange of the inner pot, wherein the locking structure is configured to linearly move, depending on a rotation angle of the rotation cover, between a locking position at which the engagement protrusion is located to overlap the flange of the inner pot in a vertical direction and an unlocking position spaced apart outward from the locking position in a radial direction.

In addition, the rotation cover includes a guide groove including a first region spaced apart from a center of the rotation cover by a first distance and a second region spaced apart from the center of the rotation cover by a distance ranging from a first distance to a second distance from the center of the rotation cover, and the locking structure further includes a guide protrusion accommodated in the guide groove and located in one of the first region and the second region depending on a rotation angle of the rotation cover.

In addition, the first distance is smaller than the second distance, and when the guide protrusion is located in the first region, the locking structure is located at the locking position, and when the guide protrusion is located in the second region, the guide protrusion is located at the unlocking position.

In addition, the cooking device further includes: a pressure control device including a cylinder including a first inner passage communicating with the accommodation space in the inner pot and a weight provided on the cylinder and configured to open/close the first inner passage depending on a steam pressure of the accommodation space; and a lift pin configured to selectively press the weight by moving up and down between a pin-down position and a pin-up position depending on the rotation angle of the rotation cover.

In addition, the first region includes a first position and a second position sequentially located in a direction in which the guide groove extends, and when the guide protrusion is located at the first position, the lift pin is located at the pin-down position, and when the guide protrusion is located at the second position, the lift pin is located at the pin-up position, thereby pressing the weight.

In addition, the cooking device further includes a safety protrusion formed on the inside of the rotation cover in a radial direction; and a safety cover configured to apply an external force toward the safety protrusion under the safety protrusion and to hinder the rotation cover from rotating when coming into contact with a side wall of the safety protrusion, wherein, when the guide protrusion is located at the first position, the safety cover comes into contact with the side wall of the safety protrusion, and when the guide protrusion is located at the second position, the safety cover comes into contact with a lower portion of the safety protrusion.

The cooking device according to the technical idea of the present disclosure is capable of providing safety in use by guiding the steam pressure of the inner pot to the exterior even when the lid is incompletely closed.

### BRIEF DESCRIPTION OF THE DRAWINGS

FIG. 1 is a perspective view illustrating a lid assembly 100 of a cooking device according to exemplary embodiments of the present disclosure.

FIG. 2 is a perspective view illustrating the main components of the lid assembly 100 of FIG. 1.

FIG. 3 is an exploded perspective view illustrating the main components of the lid assembly 100 of FIG. 1.

FIGS. 4A and 4B are cross-sectional views illustrating the operation of the locking structure performed by the rotation of a rotation cover.

FIG. 5 is a plan view illustrating the rotation cover.

FIGS. 6A to 6C are cross-sectional views illustrating the operation of the locking structure performed by the rotation of the rotation cover.

FIG. 7A is a perspective view illustrating an opening/closing state when a guide protrusion 330 is located at a first position L1.

FIG. 7B is a cross-sectional view illustrating a pin-down position of a lift pin 140 when the guide protrusion 330 is located at the first position L1.

FIG. 8A is a perspective view illustrating an opening/closing state when the guide protrusion 330 is located at a second position L2.

FIG. 8B is a cross-sectional view illustrating a pin-up position of the lift pin 140 when the guide protrusion 330 is located at the second position L2.

### DETAILED DESCRIPTION

Hereinafter, embodiments of the present disclosure will be described in detail with reference to the accompanying drawings. The same reference numerals are used for the same components in the drawings, and duplicate descriptions thereof will be omitted.

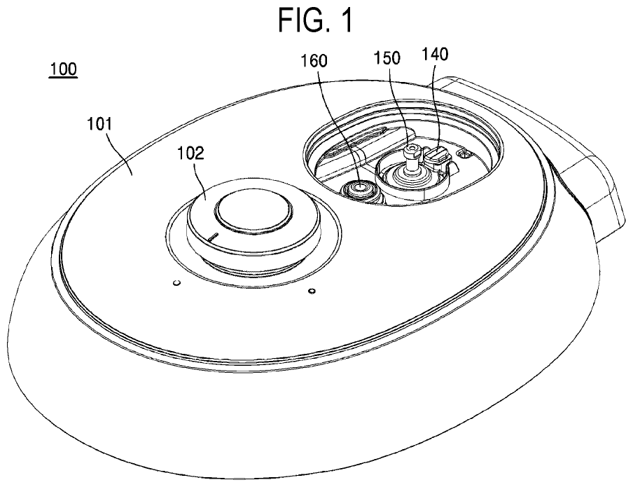

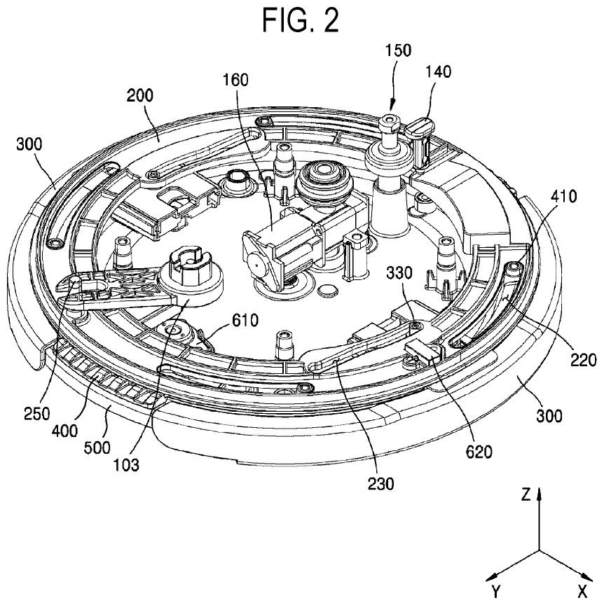

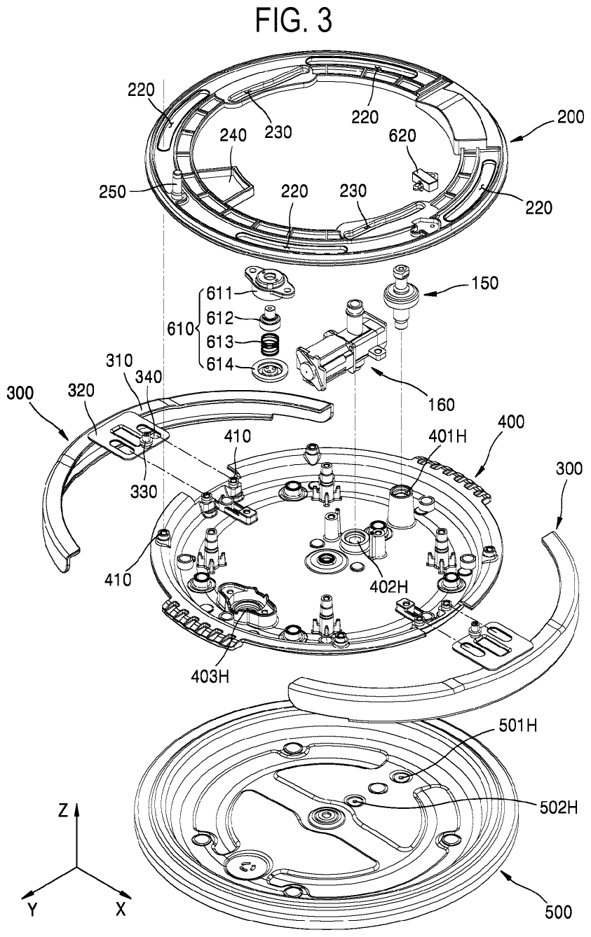

FIG. 1 is a perspective view illustrating a lid assembly 100 of a cooking device according to exemplary embodiments of the present disclosure. FIG. 2 is a perspective view illustrating the main components of the lid assembly 100 of FIG. 1. FIG. 3 is an exploded perspective view illustrating the main components of the lid assembly 100 of FIG. 1.

Referring to FIGS. 1 to 3, the cooking device may include a main body (not illustrated) including a cooking space in which cooking ingredients can be cooked, and a lid assembly 100 installed on the main body.

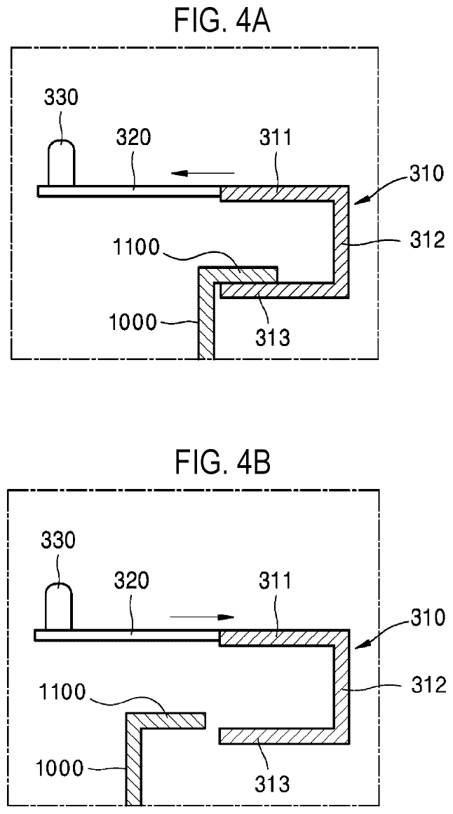

The main body may accommodate an inner pot (1000 in FIG. 4A) configured to accommodate cooking ingredients. The inner pot 1000 may have a container shape and may include an accommodation space in which cooking materials are accommodated. The inner pot 1000 may be detachably mounted in the cooking space of the main body. In exemplary embodiments, the inner pot 1000 may include a flange (1100 in FIG. 4A) protruding outward from the upper end edge thereof. The flange 1100 may extend along the upper end edge of the inner pot 1000. A plurality of flanges 1100, which are spaced apart from each other along the upper end edge of the inner pot 1000, may be arranged at the upper end of the inner pot 1000. The main body may include a heating source for heating the cooking ingredients accommodated in the inner pot 1000. For example, the main body may include a hot plate-type heater or an induction heating-type heater.

The lid assembly 100 may cover the cooking space of the body and/or the accommodation space in the inner pot 1000. The lid assembly 100 may be configured to seal the accommodation space in the inner pot 1000 and/or the cooking space in the main body such that a pressure suitable for cooking is formed in the accommodation space in the inner pot 1000 while the cooking ingredients are being cooked. In exemplary embodiments, the lid assembly 100 may be hinged to one side of the main body and may rotate about a hinge axis. The lid assembly 100 may rotate between a closed position at which the lid assembly covers the accommodation space in the inner pot 1000 and an opened position at which the lid assembly opens the accommodation space in the inner pot 1000.

In exemplary embodiments, the lid assembly 100 may be detachably coupled to the main body.

The lid assembly 100 may include a lid cover 101, an inner pot cover 500, a top plate 400, a rotation cover 200, a pressure control device 150, a solenoid valve 160, and a locking structure 300.

The lid cover 101 may be coupled to the main body. The lid cover 101 may form the exterior of the lid assembly 100. The lid cover 101 may provide a space in which various electric components can be installed.

The inner pot cover 500 may be disposed under the lid assembly 100 facing the inner pot 1000. The inner pot cover 500 may be mounted on the top plate 400 and/or the lid cover 101. The inner pot cover 500 may cover the inner pot 1000 accommodated in the main body. The inner pot cover 500 may include a first lower steam hole 501H and a second lower steam hole 502H which communicate with the accommodation space in the inner pot 1000.

The top plate 400 may be disposed on the inner pot cover 500. The top plate 400 may be disposed within the lid cover 101 and coupled to the lid cover 101. The top plate 400 may include a first upper steam hole 401H communicating with the first lower steam hole 501H in the inner pot cover 500 and a second upper steam hole 402H communicating with the second lower steam hole 502H.

The rotation cover 200 may be disposed on the top plate 400. The rotation cover 200 may have a ring shape extending substantially along the edge of the top plate 400. The rotation cover 200 may be rotatably coupled to the top plate 400 along the edge of the top plate 400. The rotation cover 200 may be configured to rotate, about the rotation axis direction (Z direction), in a first rotation direction (e.g., clockwise direction) and a second rotation direction (e.g., counterclockwise direction) opposite to the first rotation direction.

The rotation cover 200 may be configured to rotate in conjunction with the rotation of a manipulation handle 102 protruding from the lid cover 101. The rotation of the manipulation handle 102 in the first rotation direction may cause the rotation cover 200 to rotate in the first rotation direction, and the rotation of the manipulation handle 102 in the second rotation direction may cause the rotation cover 200 to rotate in the second rotation direction.

More specifically, the manipulation handle 102 and the rotation cover 200 may be connected to each other via a connection lever 103 which rotates about the rotation axis of the manipulation handle 102 when the manipulation handle 102 rotates. One end of the connection lever 103 may be connected to the manipulation handle 102, and the other end of the connection lever 103 may be connected to a connection protrusion 250 of the rotation cover 200. For example, when the manipulation handle 102 is rotated by a user's manipulation, the connection lever 103 may rotate in conjunction with the rotation of the manipulation handle 102, and the rotation cover 200 connected to the connection lever 103 via the connection protrusion 250 may rotate along the edge of the top plate 400.

The rotation cover 200 may be configured to rotate on the top plate 400 within a predetermined rotation angle range. The rotation cover 200 may include a rotation restriction groove 220 extending along the rotation direction of the rotation cover 200 or along the edge of the rotation cover 200. The rotation restriction groove 220 may limit the rotation movement range of the rotation cover 200 while guiding the rotation movement of the rotation cover 200.

More specifically, a fastening structure such as a screw may be inserted into a boss 410 of the top plate 400 below the rotation restriction groove 220. The rotation of the rotation cover 200 may be limited between a position where the fastening structure is engaged with one end portion of the rotation restriction groove 220 and a position where the fastening structure is engaged with the other end portion of the rotation restriction groove 220.

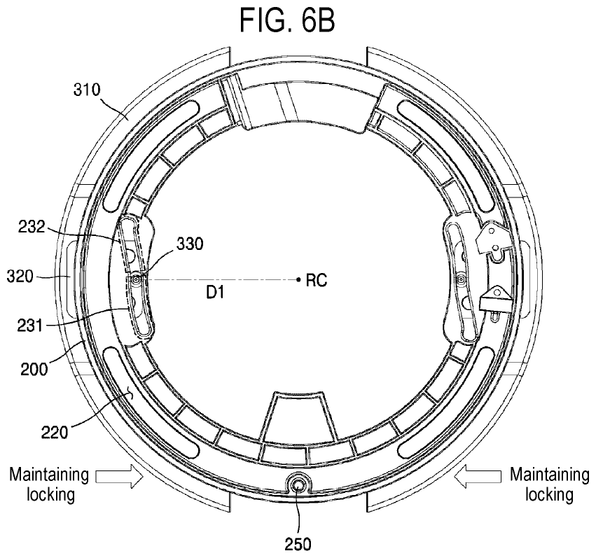

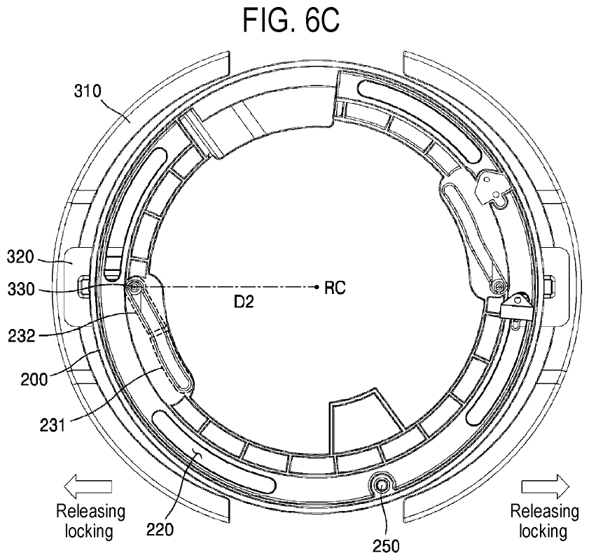

The pressure control device 150 may be configured to control the pressure of the accommodation space in the inner pot 1000 by controlling the discharge of steam depending on the pressure level of the accommodation space in the inner pot 1000. The pressure control device 150 may be mounted on the top plate 400. The pressure control device 150 may include a poise valve configured to maintain the pressure (i.e., steam pressure) of the accommodation space in the inner pot 1000 at a predetermined pressure by using a weight (e.g., 152 in FIG. 7B). The pressure control device 150 may have a passage communicating with the accommodation space in the inner pot 1000 through the first lower steam hole 501H and the first upper steam hole 401H, and may be configured to selectively discharge steam introduced into the passage.

The solenoid valve 160 may be mounted on the top plate 400. The solenoid valve 160 may be configured to adjust the pressure of the accommodation space in the inner pot 1000 by discharging steam in the accommodation space in the inner pot 1000 in response to an electrical control signal. The solenoid valve 160 may include an inner passage communicating with the accommodation space in the inner pot 1000 through the second lower steam hole 502H and the second upper steam hole 402H and may be configured to selectively open/close the inner passage in response to an electrical control signal. For example, the solenoid valve 160 may be configured to quickly release the residual pressure in the inner pot 1000 to the exterior by opening the inner passage when cooking is completed.

The solenoid valve 160 may be configured to selectively open/close the inner passage in response to an electrical control signal generated based on a reed switch 620. The electrical control signal may be generated based on the distance between the reed switch 620 and a marker 630 (see FIG. 7A). The marker 630 may be disposed inside the lid cover 101. The marker 630 may be a magnetic object, for example, a magnet. When the distance between the reed switch 620 and the marker 630 increases, the marker 630 may open the inner passage in the solenoid valve 160, and when the distance between the reed switch 620 and the marker 630 decreases, the marker 630 may close the inner passage in the solenoid valve 160.

The locking structure 300 may be configured to move between a locking position where the locking structure 300 is locked with respect to the flange 1100 of the inner pot 1000 and an unlocking position where the locking structure 300 is unlocked with respect to the flange 1100 of the inner pot 1000. Switching between the locking position and the unlocking position of the locking structure 300 may be configured to be performed in conjunction with the rotation of the rotation cover 200.

The locking structure 300 may be mounted on the top plate 400 and may include an engagement protrusion (313 in FIG. 4A) configured to be selectively engaged with the flange 1100 of the inner pot 1000. The locking position of the locking structure 300 may be a position where the engagement protrusion 313 of the locking structure 300 overlaps the flange 1100 of the inner pot 1000 in the vertical direction, and the unlocking position of the locking structure 300 may be a position where the engagement protrusion 313 of the locking structure 300 does not overlap the flange 1100 of the inner pot 1000 in the vertical direction. While cooking of the cooking ingredients contained in the inner pot 1000 is in progress, the locking structure 300 may be located at the locking position, and when the engagement protrusion 313 is fixed to the inner pot 1000, the inner port 1000 and the inner pot cover 500 or the inner port 1000 and the top plate 400 may be firmly fixed to each other. The locking structure 300 may be described in more detail with reference to drawings to be described later.

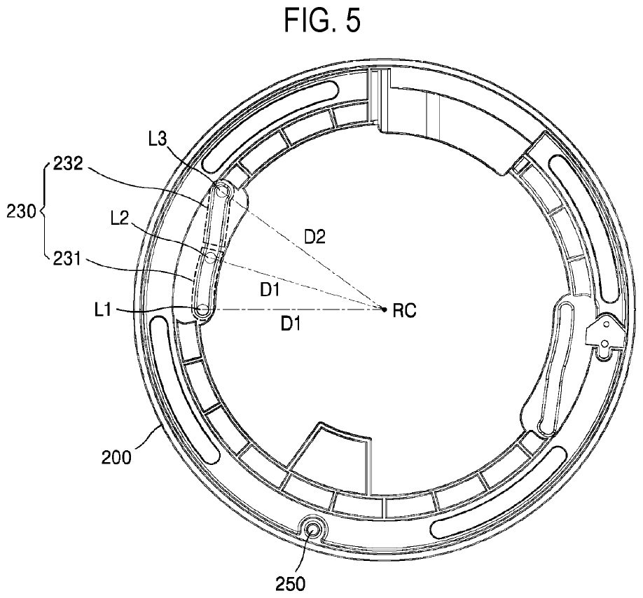

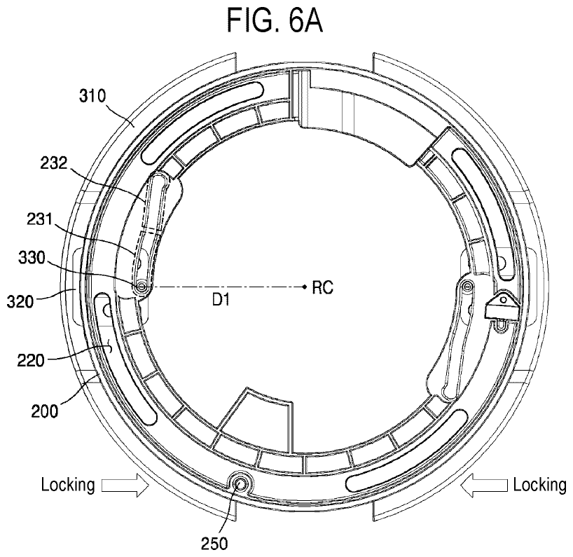

FIGS. 4A and 4B are cross-sectional views illustrating the operation of the locking structure based on the rotation of the rotation cover. Specifically, FIG. 4A illustrates a state when the locking structure 300 is located at the locked position, and FIG. 4B illustrates a state when the locking structure 300 is located at the unlocked position. FIG. 5 is a plan view illustrating the rotation cover. FIGS. 6A to 6C are cross-sectional views illustrating the operation of the locking structure performed by the rotation of the rotation cover.

Referring to FIGS. 3, 4A, and 4B together with FIG. 5, the locking structure 300 may include a locking blade 310 extending along the edge of the top plate 400 and having a curved shape in a plan view. The locking blade 310 may include a side wall 312 surrounding the edge of the top plate 400 and the edge of the inner pot cover 500 in a lateral direction, an upper body 311 extending inward from the upper end of the side wall 312 and engaged with the edge of the top surface of the top plate 400, and a lower body extending inward from the lower end of the side wall portion 312. The lower body of the locking blade 310 may include an engagement protrusion 313 configured to be fixedly engaged with the flange 1100 of the inner pot 1000.

The locking structure 300 may include a connection plate 320 connected to the inner periphery of the upper end of the locking blade 310 and disposed between the top plate 400 and the rotation cover 200. The connection plate 320 may include a groove 340 extending in a linear direction. The groove 340 in the connection plate 320 may guide the linear movement of the locking structure 300 while limiting the movement range of the locking structure 300. More specifically, a fastening structure such as a screw may be inserted into a boss 410 of the top plate 400 through the groove 340 in the connection plate 320. The linear movement of the locking structure 300 may be limited between a position where one end of the groove 340 is engaged with the fastening structure and a position where the other end of the groove 340 is engaged with the fastening structure.

The rotation cover 200 may include a guide groove 230 extending generally along the rotation direction of the rotation cover 200, and the connection plate 320 of the locking structure 300 may include a guide protrusion 330 inserted into the guide groove 230 of the rotation cover 200. While the rotation cover 200 rotates, the linear movement of the locking structure 300 may be realized by physical interference between the rotation cover 200 and the guide protrusion 330 accommodated in the guide groove 230.

In exemplary embodiments, as illustrated in FIG. 5, the guide groove 230 may include a first position L1, a second position L2, and a third position L3 which are sequentially disposed between one end and the other end of the guide groove 230 along the extending direction of the guide groove 230. The first position L1 and the second position L2 of the guide groove 230 may be spaced apart from the rotation center RC of the rotation cover 200 by a first distance D1, and the third position L3 of the guide groove 230 may be spaced apart from the rotation center RC of the rotation cover 200 by a second distance D2 greater than the first distance D1. The guide groove 230 may include a safety region 231 and an opening/closing region 232. The region of the guide groove 230 from the first position L1 to the second position L2 may be referred to as the safety region 231, and the region from the second position L2 to the third position L3 may be referred to as the open/close region 232. The safety region may be a region spaced apart from the rotation center RC by a first distance D1, and the opening/closing region may be a region spaced apart from the rotation center RC by a second distance D2.

Depending on the rotation angle of the rotation cover 200, the relative position of the guide protrusion 330 with respect to the guide groove 230 varies. When the guide protrusion 330 is located in the safety region 231 of the guide groove 230, which is spaced apart from the rotation center RC of the rotation cover 200 by substantially the same first distance D1, the locking structure 300 may be located at a locking position where the engagement protrusion 313 can be engaged with the flange 1100 of the inner pot 1000. When the guide protrusion 330 is located in the opening/closing region 232 of the guide groove 230 spaced apart from the rotation center RC of the rotation cover 200 by the second distance D2 greater than the first distance D1, the locking structure 300 may be located at the unlocking position spaced radially outward from the locking position. While the guide protrusion 330 moves in the opening/closing region 232 of the guide groove 230, the locking structure 300 may move outward in the radial direction or inward in the radial direction. Specifically, while the guide protrusion 330 moves from the second position L2 toward the third position L3 of the guide groove 230, the locking structure 300 moves outward in the radial direction. In contrast, while the guide protrusion 330 moves from the third position L3 toward the second position L2 of the guide groove 230, the locking structure 300 moves inward in the radial direction.

That is, referring to FIGS. 6A and 6B, when the guide protrusion 330 moves within the safety region 231 by rotating the rotation cover 200 counterclockwise by the connection protrusion 250, the position of the locking structure 300 can be maintained as it is. That is, the locked state between the locking structure 300 and the inner pot 1000 can be maintained.

Referring to FIGS. 6B and 6C, when the guide protrusion 330 moves within the opening/closing region 232 by rotating the rotation cover 200 counterclockwise by the connection protrusion 250, the locking structure 300 can be moved outward in the radial direction. That is, the locking structure 300 can be moved to the unlocked position, and the locked state between the locking structure 300 and the inner pot 1000 can be released.

In the cooking device according to an exemplary embodiment of the present disclosure, the locking operation or unlocking operation between the locking structure 300 and the inner pot 1000 can be performed by converting the rotation motion of the rotation cover 200 into the linear motion of the locking structure 300.

FIG. 7A is a perspective view illustrating an opening/closing state when the guide protrusion 330 is located at the first position L1, and FIG. 7B is a cross-sectional view illustrating a pin-down position of the lift pin 140 when the guide protrusion 330 is located at the first position L1.

Referring to FIGS. 3 and 7A, the safety cover 610 may be inserted into and disposed in the seating portion 403H formed on the top plate 400. The safety cover 610 may come into contact with the safety protrusion 240 formed inside the rotation cover 200.

When the guide protrusion 330 is located at the first position L1 or the third position L3, the safety protrusion 240 can be fixed by the safety cover 610. That is, when the rotation cover 200 is locked or unlocked, the safety cover 610 fixes the safety protrusion 240 so that the rotation cover 200 can be prevented from rotating due to a relatively small impact. However, when a user manipulates the manipulation handle 102 so that the rotation cover 200 receives a relatively large external force, the safety cover 610 may not fix the safety protrusion 240. For example, the safety cover 610 may apply an elastic force in the +Z-axis direction by an elastic member, and when the guide protrusion 330 is located at the first position L1 or the third position L3, the safety cover 610 may be disposed to block a portion of the sidewall of the safety protrusion 240. Therefore, although the rotation cover 200 may be prevented from rotating due to a relatively small impact, when an external force greater than the elastic force of the elastic member is applied via the manipulation handle 102, the rotation cover 200 may rotate despite the fixing operation of the safety cover 610.

Referring to FIG. 7A, when the rotation cover 200 is in the locked state, the reed switch 620 may be located at a relatively close distance from the marker 630. The reed switch 620 may generate an electrical control signal by detecting the magnetism of the marker 630, and the inner passage in the solenoid valve 160 may be closed in response to the electrical control signal.

Referring to FIGS. 1, 7A and 7B, the lift pin 140 may be movably mounted in the through-hole in the lid cover 101, and the head of the lift pin 140 may protrude from the lid cover 101. The rotation cover 200 may include a first surface portion 141 and a second surface portion 142. The first surface portion 141 may be formed at a first height, and the second surface portion 142 may be formed at a second height higher than the first height. The lift pin 140 may move up and down by sliding on the first surface portion 141 and the second surface portion 142 due to the rotation of the rotation cover 200. As illustrated in FIG. 7A, when the lift pin 140 is supported on the first surface portion 141 disposed at the first height, the lift pin 140 may be located at the pin-down position.

As illustrated in FIG. 7B, at the pin-down position of the lift pin 140, the lift pin 140 may be spaced apart from the weight 152. Here, when it is described that the lift pin 140 is spaced apart from the weight 152, it may mean that the lift pin 140 is not in physical contact with the weight 152 by being spaced apart from the weight 152 by a predetermine distance or the lift pin 140 does not provide a sufficient external force to lift the weight 152 even though the weight 152 is in physical contact.

According to an exemplary embodiment of the present disclosure, in the locked state, the rotation cover 200 may be prevented from rotating by the safety cover 610 and the safety protrusion 240. Meanwhile, in the locked state, the inner passage in the solenoid valve 160 may be closed, and the pressure control device 150 may be in the state in which the weight 152 closes the inner passage in the cylinder 151.

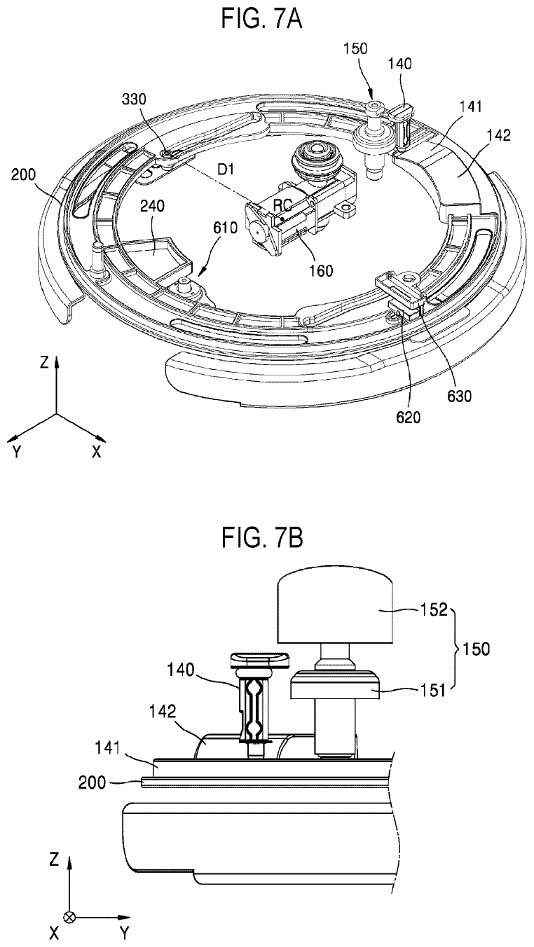

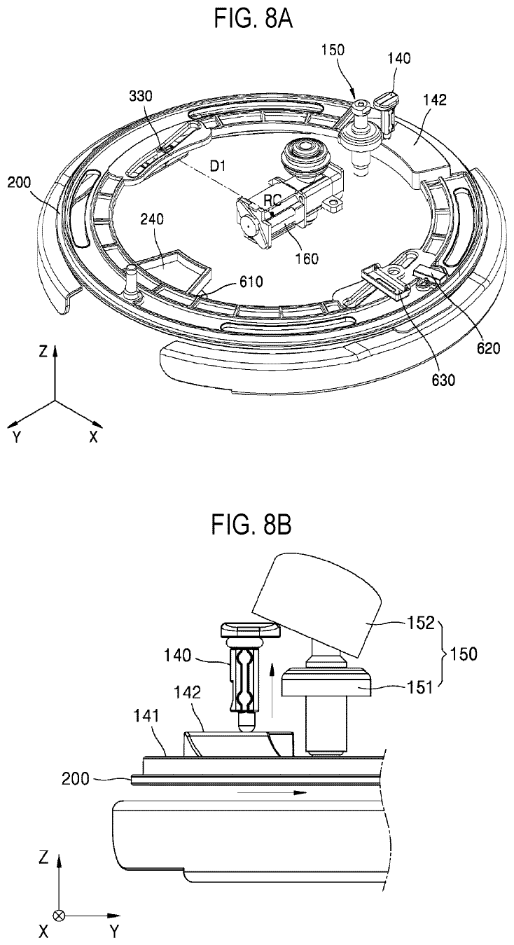

FIG. 8A is a perspective view illustrating an opening/closing state when the guide protrusion 330 is located at the second position L2, and FIG. 8B is a cross-sectional view illustrating a pin-up position of the lift pin 140 when the guide protrusion 330 is located at the second position L2.

When the guide protrusion 330 is located at the second position L2, the safety cover 610 may be located under the safety protrusion 240 and may not serve to fix the safety protrusion 240. That is, even if the safety cover 610 provides an elastic force in the +Z-axis direction, the rotation cover 200 may rotate rather than being fixed since the safety cover 610 is only in contact with the lower portion of the safety protrusion 240. However, even though a user does not operate the manipulation handle 102, the fixation by the safety cover 610 may be released due to a relatively large impact, and a safety accident may occur due to this situation.

Referring to FIGS. 4A to 6C, the rotation cover 200 according to an exemplary embodiment of the present disclosure may include a safety region 231 to allow the locking structure 300 to maintain the locked state with the inner pot 1000 even if the fixation by the safety cover 610 is released due to a defect or impact.

However, as illustrated in FIG. 8A, when the guide protrusion 330 is located at the second position L2, the distance between the reed switch 620 and the marker 630 increases, so that in a normal case, the inner passage of the solenoid valve 160 may be opened by an electrical control signal. However, when the inner passage of the solenoid valve 160 remains closed due to a defect, it is necessary to prepare for safety accidents by discharging steam inside the inner pot 1000.

Accordingly, referring to FIG. 8B, when the guide protrusion 330 is located at the second position L2, the lift pin 140 may move up by sliding from the first surface portion 141 to the second surface portion 142, and the head portion of the lift pin 140 may lift the weight 152. When the weight 152 is lifted, since the inner passage of the cylinder 151 is forcibly opened, the steam pressure of the accommodation space of the inner pot 1000 can be maintained at the atmospheric pressure or a level close thereto.

According to an exemplary embodiment of the present disclosure, the safety cover 610, which prevents the rotation cover 200 from rotating unnecessarily, may serve as a primary safety device. Nonetheless, when the rotation cover 200 rotates unnecessarily, the reed switch 620 may open the inner passage of the solenoid valve 160 in response to an electrical control signal so that the steam pressure of the accommodation space in the inner pot 1000 can be maintained at the level of atmospheric pressure. Thus, the reed switch 620 and the solenoid valve 160 may serve as a secondary safety device. Nonetheless, when the inner passage of the solenoid valve 160 is not opened, the lift pin 140 may slide from the first surface portion 141 to the second surface portion 142 to lift the weight 152 so that the steam pressure of the accommodation space in the inner pot 1000 can be maintained at the level of atmospheric pressure level. Thus, the lift pin 140 and the first and second surface portions 141 and 142 may serve as a tertiary safety device.

The technical idea of the present disclosure described in the foregoing is not limited to the above-described embodiments and the accompanying drawings. In addition, it will be obvious to a person ordinarily skilled in the art to which the present disclosure pertains that various substitutions, modifications, and changes are possible without departing from the scope of the technical idea of the present disclosure.

1. A cooking device comprising:
a main body in which an inner pot is accommodated;
a top plate provided in a lid cover coupled to the main body;
a rotation cover coupled to the top plate to be rotatable along an edge of the top plate;
a locking structure comprising an engagement protrusion configured to be engaged with a flange of the inner pot;
a safety protrusion formed on the inside of the rotation cover in a radial direction; and
a safety cover configured to apply an external force toward the safety protrusion under the safety protrusion based on the elastic force of the elastic member and to hinder the rotation cover from rotating when coming into contact with a side wall of the safety protrusion,
wherein the locking structure is configured to linearly move, depending on a rotation angle of the rotation cover, between a locking position at which the engagement protrusion is located to overlap the flange of the inner pot in a vertical direction and an unlocking position spaced apart outward from the locking position in a radial direction, and
wherein when the guide protrusion is located at the first position, the safety cover comes into contact with the side wall of the safety protrusion, and when the guide protrusion is located at the second position, the safety cover comes into contact with a lower portion of the safety protrusion.

2. The cooking device of claim 1, wherein the rotation cover comprises a guide groove comprising a first region spaced apart from a center of the rotation cover by a first distance and a second region spaced apart from the center of the rotation cover by a distance ranging from a first distance to a second distance from the center of the rotation cover, and
the locking structure further comprises a guide protrusion accommodated in the guide groove and located in one of the first region and the second region depending on a rotation angle of the rotation cover.

3. The cooking device of claim 2, wherein the first distance is smaller than the second distance, and
when the guide protrusion is located in the first region, the locking structure is located at the locking position, and when the guide protrusion is located in the second region, the guide protrusion is located at the unlocking position.

4. The cooking device of claim 2, further comprising:
a pressure control device comprising a cylinder including a first inner passage communicating with the accommodation space in the inner pot and a weight provided on the cylinder and configured to open/close the first inner passage depending on a steam pressure of the accommodation space; and
a lift pin configured to selectively press the weight by moving up and down between a pin-down position and a pin-up position depending on the rotation angle of the rotation cover.

5. The cooking device of claim 4, wherein the first region comprises a first position and a second position sequentially located in a direction in which the guide groove extends, and
when the guide protrusion is located at the first position, the lift pin is located at the pin-down position, and when the guide protrusion is located at the second position, the lift pin is located at the pin-up position, thereby pressing the weight.

6. (canceled)
